(19) United States
(12) Patent Application Publication
(10) Pub. No.: US 2010/0226484 A1
(43) Pub. Date: Sep. 9, 2010

(54) METHOD OF OPERATING A TELECOMMUNICATIONS SYSTEM FOR PROVIDING A REMOTELY ACCESSIBLE PERSONAL TELEPHONE DIRECTORY

(76) Inventor: Paul Wilkins, Las Vegas, NV (US)

Correspondence Address: WEISS & MOY PC, 4204 NORTH BROWN AVENUE, SCOTTSDALE, AZ, 85251, US

(21) Appl. No.: 12/787,747

(22) Filed: May 26, 2010

Related U.S. Application Data
(63) Continuation-in-part of application No. 11/656,030, filed on Jan. 22, 2007.

(51) Int. Cl. H04M 3/493; H04M 1/64; H04M 1/56

(52) U.S. Cl. 379/88.23; 379/218.01; 379/142.01

(57) ABSTRACT

A driver observation system has a plurality of camera modules mounted to an exterior area of a vehicle for providing real time video images on an exterior area of the vehicle. A control mechanism is coupled to the plurality of camera modules to control operation of each of the plurality of camera modules and to switch between different camera modules for viewing. A display system coupled to the control mechanism to show the real time video images. A recording device is coupled to the control mechanism for storing the real time video images.

### RELATED APPLICATIONS

The present application is a Continuation-In-Part of a patent application entitled “METHOD OF OPERATING A TELECOMMUNICATIONS SYSTEM FOR PROVIDING A REMOTELY ACCESSIBLE PERSONAL TELEPHONE DIRECTORY”, Ser. No. 11/656,030, filed Jan. 22, 2007, in the name of the same inventor and which is claims priority from provisional application No. ______ entitled PERSONAL TELEPHONE DIRECTORY filed on Nov. 13, 2006 in the name of the applicant of this application.

### FIELD OF THE INVENTION

This invention relates generally to telecommunications and, more particularly, to a method of operating a telecommunications system for providing a personal telephone directory that is capable of storing numerous telephone numbers and that may be accessed remotely from various parts of the world.

### BACKGROUND OF THE INVENTION

Telephones are a significant part of everyday life for many people. Many individuals frequently use more than one telephone and therefore have more than one telephone number, such as home, work, and cellular telephone numbers. In order to reach a particular individual by telephone, it is of course necessary to know that individual's telephone number or numbers. Remembering different telephone numbers for different individuals may become difficult, due in part to the amount of telephone numbers that particular individuals may have. Further, because it is not uncommon for particular individuals to have “unlisted” telephone numbers, such telephone numbers may not be retrieved from a public telephone book or from directory assistance. The same is typically true for cellular telephone numbers. Thus, individuals have been known to keep track of telephone numbers by various methods, such as by the use of address books, notebooks, slips of paper, etc. In addition, with the use of modern technology, telephone numbers may be electronically stored in directories in an individual's cellular telephone, landline telephone, personal digital assistant (“PDA”), etc.

Limitations exist with the aforementioned methods of keeping track of telephone numbers. For example, sometimes there are limits with respect to the amount of telephone numbers that may be stored in an electronic directory on a landline telephone, cellular telephone, or PDA. Further, sometimes individuals may program different telephone numbers into a landline telephone, but fail to also program such telephone numbers into the individual's cellular telephone or PDA, and vice versa. Further still, sometimes individuals forget to bring their cellular telephones with them when leaving their homes, places of work, etc. As a still further example, sometimes a cellular telephone's battery runs out and the telephone becomes unusable. All of these limitations may become problematic when an individual needs to make a telephone call but does not have the telephone number handy and cannot retrieve the telephone number from the individual's cellular telephone, landline telephone, or PDA, etc.

It would therefore be convenient for individuals to have personal telephone directories that are capable of maintaining lists of all the telephone numbers that individuals wish to have in those directories. Such personal telephone directories may be less burdensome than having to program different telephone numbers into multiple directories, such as electronic landline, cellular telephone, and PDA directories. Maintaining such personal telephone directories may also be less expensive than contacting directory assistance. It would also be convenient for an individual to be able to retrieve from a personal telephone directory various personal numbers and call those various personal numbers from anywhere in the world.

A need therefore exists for a method of operating a telecommunications system for providing a personal telephone directory system that is capable of storing numerous telephone numbers and that may be accessed remotely from various parts of the world.

The present invention satisfies these needs and provides other, related advantages.

### SUMMARY

In accordance with one embodiment, a method of operating a telecommunications system for providing a remotely accessible personal telephone directory is disclosed. The method comprising the steps of: providing a telephone service subscription for a user, wherein the telephone service subscription includes a personal telephone number and an electronic personal telephone directory for the user; accepting an inputting of the user's personal telephone number; accepting an inputting of one of a personal code and pin number; prompting the user to enter a number corresponding to a service of the electronic personal telephone directory; and wherein providing the telephone service subscription further comprises providing a voice recording service on the telecommunications system.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a flow chart showing the steps involved in an embodiment of the present invention;

FIG. 2 is a flow chart showing the steps involved in an embodiment of the present invention;

FIG. 3 is a flow chart showing the steps involved in an embodiment of the present invention;

FIG. 4 is a flow chart showing the steps involved in an embodiment of the present invention.

### DETAILED DESCRIPTION

The present invention allows a user to access a personal telephone directory in order to retrieve and call various stored personal telephone numbers from virtually any telephone in the world. A remotely accessible personal telephone directory is a directory designed for the purpose of allowing any telephone subscriber his or her personal directory of names and corresponding telephone numbers as an additional service provided with the subscriber's telephone service. By calling his or her personal telephone number from an outside telephone and following a series of steps, a user of a remotely accessible personal telephone directory may retrieve personal telephone numbers that have been stored in the remotely accessible personal telephone directory. The remotely accessible personal telephone directory may also be accessed by virtue of a designated telephone number that the subscriber may call using his or her telephone that is associated with the remotely accessible personal telephone directory.

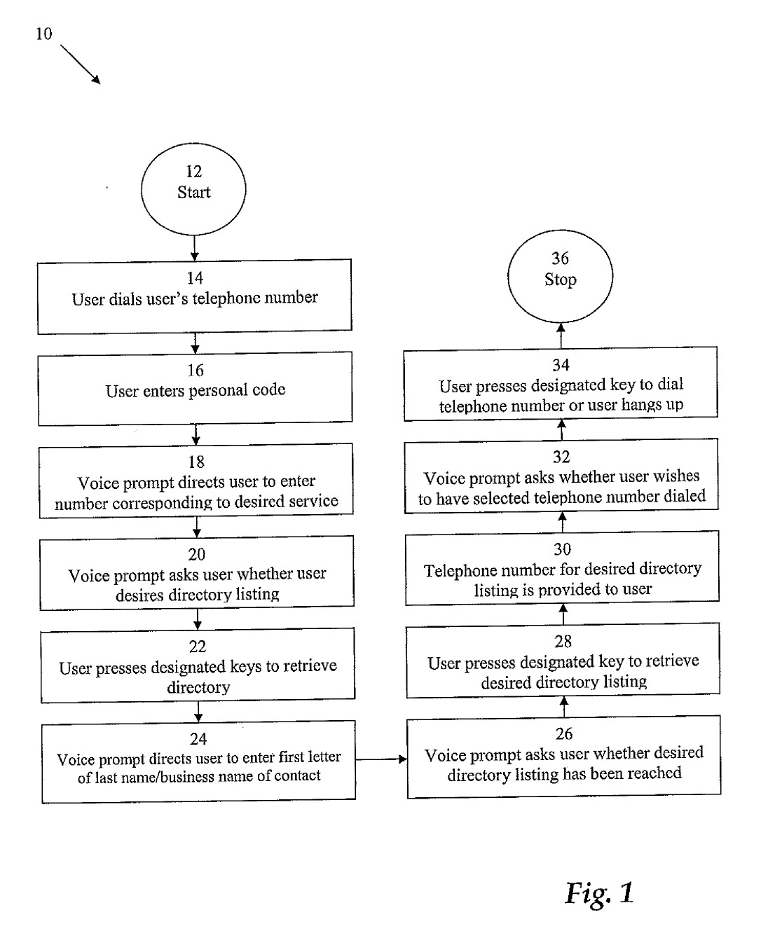

Referring first to FIG. 1, a flow chart shows the steps of a method of operating a telecommunications system for providing a remotely accessible personal telephone directory 10 (hereinafter the “method 10”), consistent with an embodiment of the present invention. In this embodiment, an outside telephone is employed to access a user's remotely accessible personal telephone directory.

A preferred embodiment of the method 10 comprises a series of steps. First, the user dials his or her telephone number 14. Next, the user enters a personal code or pin number 16, by using the keypad of the outside telephone. For example, a user may enter a code such as “*1927.” In the next step, a voice prompt directs the user to enter a number corresponding to a particular service that the user would like to use 18. For example, in a preferred embodiment, a user may enter “*1” to locate a telephone number, “*2” to enter a telephone number, “*3” to delete a previously entered telephone number, “*4” to block access to the user's telephone number by an unauthorized party, and “*5” to unblock the user's telephone number. Different numbers and/or keys may be designated for each of the aforementioned services, as desired. In addition, it may be desired to include other services, as appropriate. Once the user has selected a particular service, a voice prompt then asks the user whether the user would like a listing from his or her remotely accessible personal telephone directory 20. If the user desires such a listing, the user may then press a designated key or keys to retrieve the directory 22. For example, the user may press the star key (*) followed by the star key. Next, a voice prompt will direct the user to press the number corresponding to the first letter of a last name or business name of a person whom the user wishes to contact 24.

In the event that the user has stored multiple entries beginning with the same letter, such as the letter C, the user may then press a first designated key, such as 1, in order to scroll backward through the directory or a second designated key, such as 3, to scroll forward through the directory, until reaching the desired entry. In the next step, a voice prompt asks the user whether the desired directory listing has been reached 26. If the desired directory listing has been reached, then the user presses a designated key in order to retrieve the desired directory listing 28. For example, the user may press the pound key (#). Next, the telephone number for the desired directory listing is provided to the user 30. In the next step, a voice prompt asks the user whether the user wishes to have the selected telephone number dialed 32. If so, the user then presses a designated key or keys to dial the selected telephone number, and if not, the user simply hangs up the telephone 34. For example, the user may press the pound key in order to have the selected telephone number dialed. It may also be desired to omit steps 32 and 34.

Preferably, in this embodiment, the remotely accessible personal telephone directory is configured such that when a user dials his or her remotely accessible personal telephone directory from an outside telephone, the remotely accessible personal telephone directory may be reached virtually immediately. This may be accomplished by the user pressing a designated sequence of keys, such as the star key immediately followed by the 3 key, after the user has dialed his or her personal telephone number. After the designated sequence of keys has been pressed, the user may be immediately transferred to his or her remotely accessible personal telephone directory. Thus, a situation may be avoided wherein the user is prevented from reaching his or her remotely accessible personal telephone directory by the act of another person picking up the handset of the telephone on which the remotely accessible personal telephone directory is programmed at the same time that the user dials his or her personal telephone number.

In the event that the user is using a pay telephone to reach his or her remotely accessible personal telephone directory, it may be desired for an extra fee to be charged which may then be billed to the user's personal telephone service that he or she is required to call in order to reach his or her remotely accessible personal telephone directory.

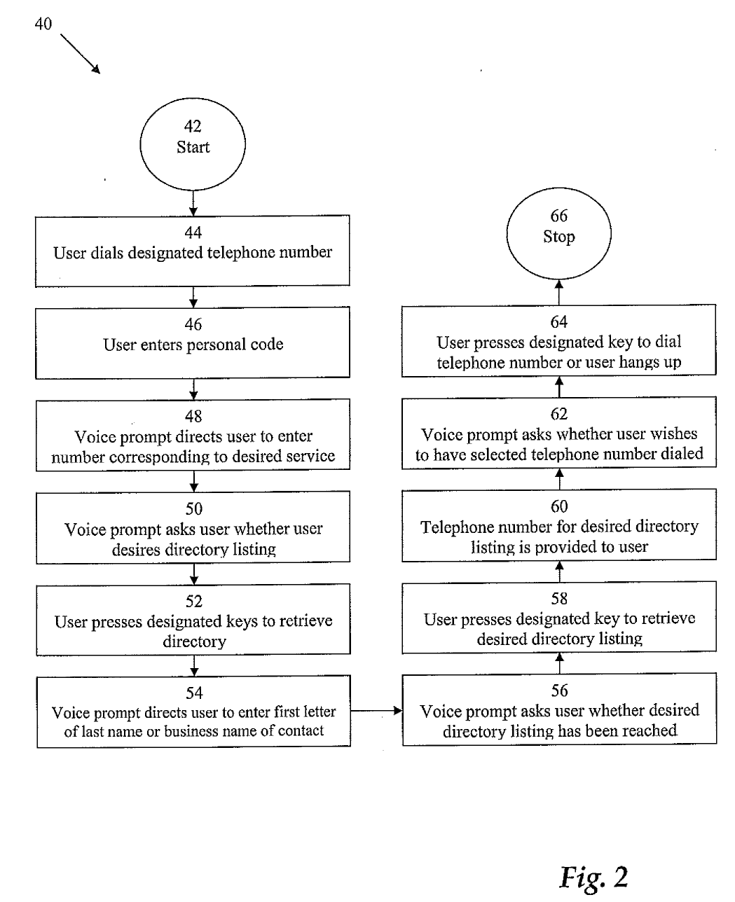

Referring now to FIG. 2, a flow chart shows the steps of a method of operating a telecommunications system for providing a remotely accessible personal telephone directory 40 (hereinafter the “method 40”), consistent with an embodiment of the present invention. In this embodiment, a user employs his or her personal telephone in order to access the remotely accessible personal telephone directory.

A preferred embodiment of the method 40 comprises a series of steps. First, the user dials a designated telephone number 44. The designated telephone number should be a number different from the user's telephone number with which the user's remotely accessible personal telephone directory is associated. Next, the user enters a personal code or pin number 46, by using the keypad of the user's personal telephone. For example, as with the method 10, a user may enter a code such as “*1927.” In the next step of the method 40, a voice prompt directs the user to enter a number corresponding to a particular service that the user would like to use 48. For example, in a preferred embodiment, a user may enter “*1” to locate a telephone number, “*2” to enter a telephone number, “*3” to delete a previously entered telephone number, “*4” to block access to the user's telephone number by an unauthorized party, and “*5” to unblock the user's telephone number. Different numbers and/or keys may be designated for each of the aforementioned services, as desired. In addition, it may be desired to include other services, as appropriate. Once the user has selected a particular service, a voice prompt then asks the user whether the user would like a listing from his or her remotely accessible personal telephone directory 50. If the user desires such a listing, the user may then press a designated key or keys to retrieve the directory 52. For example, the user may press the star key followed by the star key. Next, a voice prompt will direct the user to press the number corresponding to the first letter of a last name or business name of a person whom the user wishes to contact 54. In the event that the user has stored multiple entries beginning with the same letter, such as the letter C, the user may then press a first designated key, such as 1, in order to scroll backward through the directory or a second designated key, such as 3, to scroll forward through the directory, until reaching the desired entry. In the next step, a voice prompt asks the user whether the desired directory listing has been reached 56. If the desired directory listing has been reached, then the user presses a designated key in order to retrieve the desired directory listing 58. For example, the user may press the pound key. Next, the telephone number for the desired directory listing is provided to the user 60. In the next step, a voice prompt asks the user whether the user wishes to have the selected telephone number dialed 62. If so, the user then presses a designated key or keys to dial the selected telephone number, and if not, the user may simply hang up the telephone 64. For example, the user may press the pound key in order to have the selected telephone number dialed. It may be also desired to omit steps 62 and 64.

In a preferred embodiment of the method 40, for a user subscribing to a caller ID service, it may be relatively easy to enter a name and corresponding telephone number into the remotely accessible personal telephone directory after someone has called the user's telephone. After receiving a telephone call, such a user may log the corresponding telephone number into the user's remotely accessible personal telephone directory and have the telephone number automatically categorized. This may be accomplished with the user pressing a sequence of designated keys, such as the pound key followed by the user's personal code or pin number, followed by “*45.” In the event that the user is engaged in a call at the time he or she wishes to enter a telephone number, preferably, the user may simply “click over” to another line (in a manner similar to using a standard three-way calling system), then enter his or her personal code or pin number and enter an appropriate key or sequence of keys for logging a telephone number into the remotely accessible personal telephone directory, as described above and below.

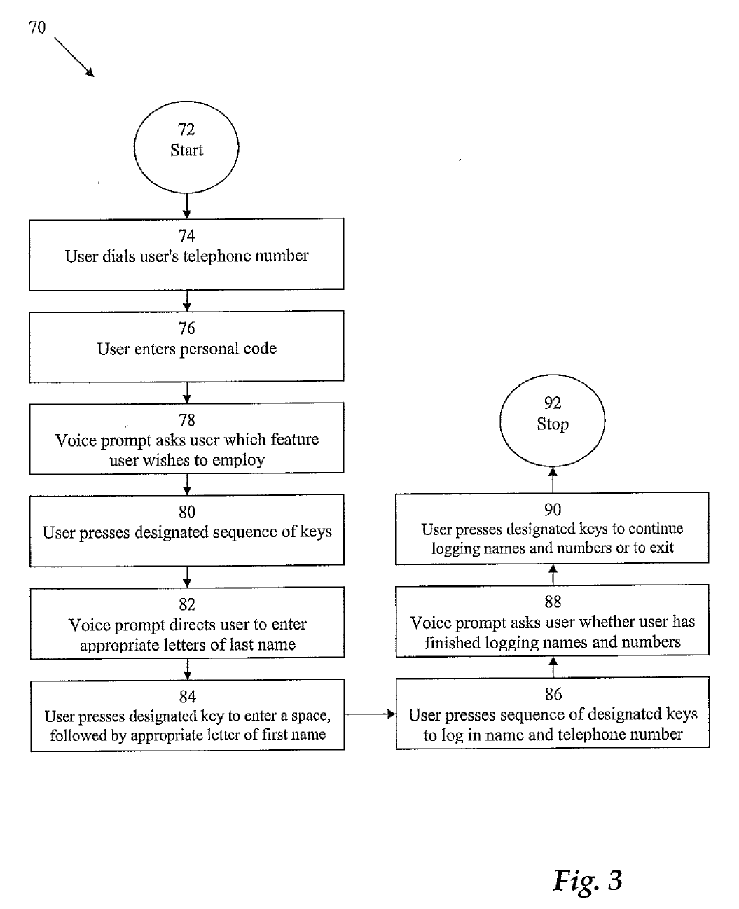

Referring now to FIG. 3, a flow chart shows the steps of a method of operating a telecommunications system for providing a remotely accessible personal telephone directory 70 (hereinafter the “method 70”), consistent with an embodiment of the present invention. In this embodiment, steps for storing information in a user's remotely accessible personal telephone directory are disclosed.

In the method 70, in order to enter a new telephone number in a user's remotely accessible personal telephone directory, use of a touch tone telephone is preferred. To enter a new telephone number, a user preferably follows a series of steps. First, the user dials his or her personal telephone number 74. Next, the user enters a personal code or pin number 76. For example, as with the methods 10 and 40, a user may enter a code such as “*1927.” Alternatively, the user may speak the code number into the telephone/cellular phone or into a headset connected to the telephone/cellular phone. Next, a voice prompt asks the user which feature of the remotely accessible personal telephone directory the user wishes to employ 78. In response, the user then presses a designated sequence of keys 80. For example, the user may press the pound key immediately followed by the 2 key.

In the next step, a voice prompt directs the user to enter the letters of the last name of the person whose telephone number the user wishes to enter into the remotely accessible personal telephone directory 82. In order to do so, the user would use a standard keypad found on most telephones, wherein, for example, the 2 key represents the letters ABC, the 3 key represents the letters DEF, the 4 key represents the letters GHI, the 5 key represents the letters JKL, the 6 key represents the letters MNO, the 7 key represents the letters PQRS, the 8 key represents the letters TUV, and the 9 key represents the letters WXYZ. As an example, in order to enter the last name of Canton, a user would press the 2 key three times to reach the letter C, then press the 2 key one time to reach the letter A, then press the 6 key twice to reach the letter N, then press the key once to reach the letter T, then press the 6 key three times to reach the letter O, and finally press the 6 key twice to reach the letter N. In order to enter the first initial of the person for whom the last name was just entered, the user would then press a designated key to enter a space 84, followed by a key corresponding to the first initial of the first name to be entered. To enter a space, for example, the user may press the star key.

Once the desired name has been entered, the user then presses a sequence of designated keys in order to log the name and corresponding telephone number into the remotely accessible personal telephone directory 86. Such a sequence of designated keys could consist of, for example, the star key immediately followed by the 1 key. Once the user has performed this process, a voice prompt asks the user whether the user has finished logging telephone numbers into the remotely accessible personal telephone directory or whether the user desires to log additional telephone numbers into the remotely accessible personal telephone directory 88. Next, the user then presses a designated key, depending on whether the user desires either to log additional telephone numbers into the remotely accessible personal telephone directory or to exit the system 90. For example, if the user desires to enter additional telephone numbers, the user may press the 2 key. If the user desires to exit the system, the user may press a sequence of designated keys, such as the pound key immediately followed by the pound key.

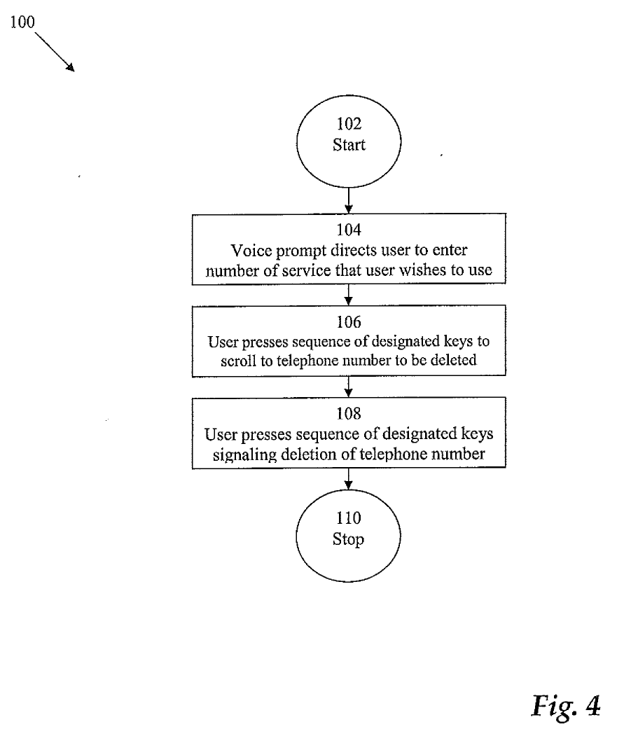

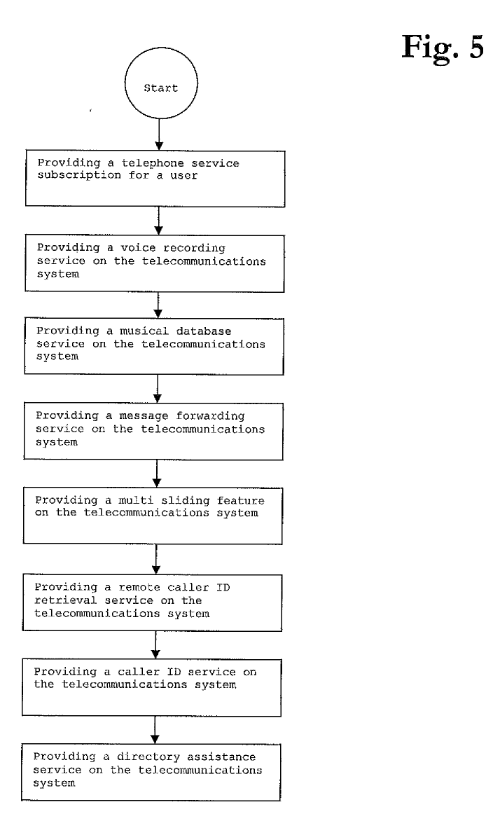

Referring now to FIG. 4, a flow chart shows the steps of a method of operating a telecommunications system for providing a remotely accessible personal telephone directory 100 (hereinafter the “method 100”), consistent with an embodiment of the present invention. In this embodiment, steps for deleting information from a user's remotely accessible personal telephone directory are disclosed.

In the method 100, if the user desires to delete a telephone number or numbers from the remotely accessible personal telephone directory, the user preferably does so from the beginning of the system, following a preferred series of steps. In the first step, a voice prompt directs the user to enter the number of the service that he or she would like to use 104. Next, the user presses a sequence of designated keys in order to scroll to the telephone number that the user wishes to delete 106. For example, the user may press the pound key immediately followed by the 3 key to accomplish this step. Once the user reaches the telephone number to be deleted, the user then presses a sequence of designated keys, signaling the deletion of the telephone number 108. For example, such designated keys may consist of the star key followed by the 6 key.

The personal telephone directory may have a Voice Record Service. The Voice Recording Service may allow a person to record any vocal information onto the personal telephone directory. The vocal information may be stored in the same and or a different database than the one storing the personal telephone directory. The Voice Record Service may work in different manners. In accordance with one embodiment, once a person has gained access to the personal telephone directory, the user may then say “Record” and any vocal data spoken will be recorded. Alternatively, a user may have to enter a code such as *123 to start the recording process. The recording may be stopped by saying a vocal command such as “End” or by pushing a designated key, such as *1. The recorded message may be retrieved at any time. A user may have to log back into the Voice Recording Service. The user may then enter a number corresponding to the recorded message. For example, the user may enter “1” for the first meassage, “2” for the second message, etc.

In accordance with another embodiment, the Voice Recording Service may also be able in case of an emergency. In this embodiment, a user may say or enter a code such as 4893 and it will alert 911 and record any vital information that may be needed for law enforcement, and be able to track your location.

The personal telephone directory may further allow the host company of the personal telephone directory to play commercials. Once a person has gained access to the personal telephone directory, the user may hear a blog for 5-12 seconds of a commercial of an advertiser that has been approved by the host company.

The personal telephone directory may further have a reset feature. The reset feature may allow the user to delete everything out of the database remotely. For users of the personal telephone directory service, the user may press a rest number from any phone. For example, the user may press *3614 from any phone and the system will delete everything out of the database remotely and will tell the system to shutdown until the user gives it further notification. By entering a second set of numbers, for example, by imputing *555, the system will restore the database information.

The personal telephone directory may further have music features. The music features may allow a user of the personal telephone directory to listen to certain music. For example, the personal telephone directory may be able to let the user say or key into the radio station the user would like to listen to. The phone or headset will be able to play it by logging into a preset number, such as *7539 or by voice activation. In a further music feature, the user may be able to enter a code such as *654382 and be able to have Mp3's or other audible files downloaded. The songs may be stored in a database of the personal telephone directory to be heard via the phone or the files may be downloaded directly to the headset/cellular phone. Once the user has entered the preset number, such as *753, the user may type in different artist names via the keypad on the telephone/cellular phone to find different musical artist and the like to download.

The personal telephone directory may further have a message forwarding service. Once the user has logged in, the user may be able to record different messages. Different messages may be recorded for different numbers or one message may be recorded for multiple numbers. The personal telephone directory will simultaneously send all the messages out at a future date, by imputing a code such as *6932, once you are ready to send the messages. Alternatively, the user may be able to input a time and date using the keypad of the telephone as to when the message(s) are sent.

The personal telephone directory may further have a multi sliding feature. Multi sliding is a way that multiple phone directories can be accessed. By imputing a predetermined number code such as *4321, the user will have access to multiple directories from different phone numbers. The multi sliding feature is possible only if a customer opens their directory to friends and family, then logs in a code and giving it to whatever selected person they make in the directory designated for friends and family.

Multi sliding may also be used to access business and personal directories from other host company customers and businesses. This is for obtaining services and information that was placed in their service directory. As long as a user can access the personal telephone directory, wherever a user is located, whether it's from an International or domestic location, the user will be able to connect easily to the system.

The personal telephone directory may further have a remote caller ID retrieval service. The remote caller ID retrieval service allows a user to retrieve phone numbers of prior calls from telephones that a user may have. By entering a predetermined code, a user will be able to hear a list of the few last person(s) that have called you on the different telephone numbers that the user may have.

The personal telephone directory may further have a phone directory retrieval service. The phone directory retrieval service will allow the user's phone numbers to automatically be saved in the host company's database. For example, if you are away from your phone, or have a lost phone or a phone that you have had in the past, when you purchase your phone you will initially be given a code such as *4867 and it will allow your phone numbers to automatically be saved in the personal telephone directory database. If you ever lose or had a phone in the past all you have to do is put in your name, your area code and phone number, and around the date that you had the phone, and the system will then allow you to retrieve your #s and upload them into another phone that you currently have by putting in a code such as *56745.

The personal telephone directory may further have the system bring your name up on someone else's Caller ID, even if it's not your phone that you're at for that brief time that you're at that phone. The user may enter a code such as *5432. By doing so, the system bring your name up on someone else's Caller ID, from wherever telephone the user is placing the call.

The personal telephone directory may further allow a user to have access to the host system database public directory assistance. The host system database public directory assistance may allow a user to find telephone numbers not in the user's directory by entering in a specified code such as *68542.

The personal telephone directory may further allow a user to have conference calling. The host system database public directory assistance may allow a user to have a conference call by entering in a specified code such as *85631.

If a person is a client of the host system's personal telephone directory service, and if another person is a client, you can tell them your code like Paul *6984 and when you have the earpiece or button less phone, connect to another party in the system. If you are not a member, you can call a 1-800 number provided by the host company and enter the code in it and it will connect you to the code that the person gave you.

When calling the host system database at a payphone or other phones you'll be able to put a code in and be able to receive calls up to 30 minutes from callers that have called you. From the database it will continue to call you even if the phone is busy, until it becomes unbusy.

The host company may further let a user create his/her own 9 to 16 digit host company number for making and receiving phone calls.

While embodiments of the disclosure have been described in terms of various specific embodiments, those skilled in the art will recognize that the embodiments of the disclosure can be practiced with modifications within the spirit and scope of the claims.

What is claimed is:

1. A method of operating a telecommunications system for providing a remotely accessible personal telephone directory, comprising the steps of:
providing a telephone service subscription for a user, wherein the telephone service subscription includes a personal telephone number and an electronic personal telephone directory for the user;
accepting an inputting of the user's personal telephone number;
accepting an inputting of one of a personal code and pin number;
prompting the user to enter a number corresponding to a service of the electronic personal telephone directory; and
wherein providing the telephone service subscription further comprises providing a voice recording service on the telecommunications system.

2. The method of claim 1, wherein providing a voice recording service further comprises:
one of entering a code or vocal command to begin a recording process; and
one of pushing a designated key of saying a stop command to end the recording process.

3. The method of claim 1, wherein providing the telephone service subscription further comprises providing a musical database service on the telecommunications system.

4. The method of claim 3, wherein providing a musical database service on the telecommunications system further comprises entering a designated code to download music files to one of a musical database of the user or a phone of the user.

5. The method of claim 3, wherein providing a musical database service on the telecommunications system further comprises entering a designated code to access designated radio stations offered by the telecommunications system.

6. The method of claim 1, wherein providing the telephone service subscription further comprises providing a message forwarding service on the telecommunications system.

7. The method of claim 6, wherein the message forwarding service allows a user to record different messages wherein one of different messages may be recorded for different telephone numbers or one message may be recorded for multiple telephone numbers.

8. The method of claim 1, wherein providing the telephone service subscription further comprises providing a multi sliding feature on the telecommunications system to allow a user to access business and personal directories from other host company customers and businesses.

9. The method of claim 1, wherein providing the telephone service subscription further comprises providing a remote caller ID retrieval service on the telecommunications system, wherein the remote caller ID retrieval service allows a user to retrieve phone numbers of prior calls from different telephones numbers that a user may have.

10. The method of claim 1, wherein providing the telephone service subscription further comprises providing a caller ID service on the telecommunications system, wherein the caller ID service may display a name of the user on a caller ID of another party from whatever telephone the user is calling from.

11. The method of claim 1, wherein providing the telephone service subscription further comprises providing a directory assistance service on the telecommunications system to allow a user to have access to the host system database public directory assistance.

12. A method of operating a telecommunications system for providing a remotely accessible personal telephone directory, comprising the steps of:
providing a telephone service subscription for a user, wherein the telephone service subscription includes a personal telephone number and an electronic personal telephone directory for the user;
accepting an inputting of the user's personal telephone number;
accepting an inputting of one of a personal code and pin number;
prompting the user to enter a number corresponding to a service of the electronic personal telephone directory; and
wherein providing the telephone service subscription further comprises providing at least one of: a voice recording service on the telecommunications system, a musical database service on the telecommunications system, a message forwarding service on the telecommunications system, a multi sliding feature on the telecommunications system, a remote caller ID retrieval service on the telecommunications system, a caller ID service on the telecommunications system, and a directory assistance service on the telecommunications system.

13. The method of claim 12, wherein providing a voice recording service further comprises:
one of entering a code or vocal command to begin a recording process; and
one of pushing a designated key of saying a stop command to end the recording process.

14. The method of claim 14, wherein providing a musical database service on the telecommunications system further comprises entering a designated code to download music files to one of a musical database of the user or a phone of the user.

15. The method of claim 14, wherein providing a musical database service on the telecommunications system further comprises entering a designated code to access designated radio stations offered by the telecommunications system.

16. The method of claim 12, wherein the message forwarding service allows a user to record different messages wherein one of different messages may be recorded for different telephone numbers or one message may be recorded for multiple telephone numbers.

17. The method of claim 13, wherein the multi sliding feature on the telecommunications system to allow a user to access business and personal directories from other host company customers and businesses.

18. The method of claim 13, wherein the remote caller ID retrieval service allows a user to retrieve phone numbers of prior calls from different telephones numbers that a user may have.

19. The method of claim 13, wherein the caller ID service may display a name of the user on a caller ID of another party from whatever telephone the user is calling from.

20. The method of claim 13, wherein the directory assistance service allows a user to have access to the host system database public directory assistance.

9. A method of operating a telecommunications system for providing a remotely accessible personal telephone directory, comprising the steps of:
providing a telephone service subscription for a user, wherein the telephone service subscription includes a personal telephone number and an electronic personal telephone directory for the user;
accepting an inputting of a designated telephone number to reach the electronic personal telephone directory;
accepting an inputting of one of a personal code and pin number;
prompting the user to enter a number corresponding to a service of the electronic personal telephone directory;
prompting the user whether the user desires a directory listing;
accepting an inputting of one of a designated key and keys to retrieve the electronic personal telephone directory;
prompting the user to enter a first letter of one of a last name and business name of a desired contact;
prompting the user whether a desired directory listing has been reached;
accepting an inputting of a designated key to retrieve the desired directory listing; and
providing the user with a telephone number for the desired directory listing.

10. The method of claim 9, wherein the one of the personal code and pin number consists of a four-digit number.

11. The method of claim 9, wherein the service of the electronic personal telephone directory is one of locating a telephone number, entering a telephone number, deleting a previously entered telephone number, blocking access to the user's telephone number by an unauthorized party, and unblocking the user's telephone number.

12. The method of claim 9, wherein the number corresponding to a service of the electronic personal telephone directory is one of the number 1 for locating a telephone number, the number 2 for entering a telephone number, the number 3 for deleting a previously entered telephone number, the number for blocking access to the user's telephone number by an unauthorized party, and the number 5 for unblocking the user's telephone number.

13. The method of claim 9, wherein the one of a designated key and keys to retrieve the electronic personal telephone directory consists of a star key followed by a star key.

14. The method of claim 9, wherein the designated key to retrieve the desired directory listing consists of a pound key.

15. The method of claim 9 further comprising the steps of:
prompting the user whether the user wishes to have the telephone number for the desired directory listing dialed; and
accepting an inputting of a designated key to dial the telephone number.

16. The method of claim 9 further comprising the step of terminating access to the electronic personal telephone directory upon a hanging up of the telephone.

17. A method of operating a telecommunications system for providing a remotely accessible personal telephone directory, comprising the steps of:
providing a telephone service subscription for a user, wherein the telephone service subscription includes a personal telephone number and an electronic personal telephone directory for the user;
accepting an inputting of the user's personal telephone number;
accepting an inputting of one of a personal code and pin number;
prompting the user to enter a number corresponding to a service of the electronic personal telephone directory;
accepting an inputting of one of a designated key and keys to store information in the electronic personal telephone directory;
prompting the user to enter letters of one of a last name and business name of a desired contact; and
accepting an inputting of a sequence of designated keys to log in the one of a last name and business name and a corresponding telephone number.

18. The method of claim 17, wherein the one of a designated key and keys to store information in the electronic personal telephone directory consists of the pound key followed by the 2 key.

19. The method of claim 17, wherein the sequence of designated keys consists of the star key followed by the 1 key.

20. The method of claim 17 further comprising the steps of:
prompting the user whether the user has finished logging in names and telephone numbers; and
accepting an inputting of one of a designated key to continue logging in names and telephone numbers and a designated key to exit.
